(19) United States
(12) Patent Application Publication
(10) Pub. No.: US 2019/0058582 A1
(43) Pub. Date: Feb. 21, 2019

(54) ACCESSING BLOCKCHAIN DATA FROM APPLICATIONS

(71) Applicant: NIIT Technology Ltd, New Delhi (IN)

(72) Inventors: Prasoon Pathak, Norristown, PA (US); Suvrata Acharya, Noida (IN)

(21) Appl. No.: 16/104,149

(22) Filed: Aug. 17, 2018

Related U.S. Application Data
(60) Provisional application No. 62/547,895, filed on Aug. 21, 2017.

(51) Int. Cl. H04L 9/06; G06F 17/30

(52) U.S. Cl. CPC H04L 9/0637; G06F 17/30377; G06F 17/30371

(57) ABSTRACT

An aspect of the present disclosure providing access to data in blockchain blocks from various applications. In one embodiment, a blockframe component receives read requests from different applications, with each read request specifying a corresponding data model and a corresponding block identifier. In response to each read request, the blockframe component interfaces with the blockchain instance to retrieve a corresponding set of data units from a respective block identified by the corresponding block identifier (specified in the read request). The blockframe component then converts the retrieved set of data units to a corresponding set of data elements according to the application data model specified in the read request and then provides the corresponding set of data elements (according to the respective application data model) to the application sending the read request. As such, accessing blockchain data from different applications is facilitated.

### PRIORITY CLAIM

The instant patent application claims priority from co-pending U.S. Provisional Patent Application entitled, “BLOCKFRAME—BLOCKCHAIN SERVICES FOR APPLICATION DEVELOPMENT”, Ser. No. 62/547,895, Filed: 21 Aug. 2017, which is incorporated in its entirety herewith to the extent not inconsistent with the disclosure herein.

### BACKGROUND OF THE DISCLOSURE

### Technical Field

The present disclosure relates to blockchain technology and more specifically to accessing blockchain data from applications.

### Related Art

Blockchain technology generally refers to use of a chain of blocks to store data, with each block in the chain storing the signature of a previous block in the chain. Consistency of a signature (in a current block) with the content of the previous block is deemed to be a condition of the existence of the link in the chain between the previous block and the current block. Accordingly, any change in one block of the chain would require alteration of all subsequent blocks in the chain for the validity of the corresponding chain.

For clarity and consistency, the terms “blockchain technology”, “blockchain block”, “blockchain link”, and “blockchain chain” are used hereinafter to refer to the technology, block, link and chain referred to in the preceding paragraph.

Applications rely on blockchain technology for storage of data, and integrity thereof. Access (including storing and retrieving) to data maintained in blockchain chains is therefore essential for implementation and operation of various applications.

Aspects of the present disclosure related to providing access to data in blockchain blocks from various applications.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present invention can be implemented.

FIG. 2A is a block diagram illustrating the manner in which data units are stored in a chain of blocks according to blockchain technology in one embodiment.

FIG. 2B depicts application data models based on which applications are operative in one embodiment.

FIG. 3 is a block diagram illustrating the manner in which applications access data stored in a blockchain block in one prior approach.

FIG. 4 is a block diagram illustrating the manner in which applications access data stored in a blockchain chain according to an aspect of the present disclosure

FIG. 5 is a sequence diagram illustrating the operation of blockframe component in one embodiment.

FIGS. 6A and 6B illustrate the manner in which different applications are implemented according to an aspect of the present disclosure.

FIG. 7A is a block diagram illustrating an implementation of blockframe component according to an aspect of the present disclosure.

FIG. 7B depicts the details of a domain specific language (DSL) according to an aspect of the present disclosure.

FIG. 8 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

1. Overview

An aspect of the present disclosure provides for a system containing a blockchain instance, multiple applications, and a blockframe component that provides access to data stored in the blockchain instance to the multiple applications. The blockchain instance stores data units in a chain of blocks according to blockchain technology and also specifies a set of operations for accessing the data in the chain of blocks. An application implemented to operate with an application data model sends a write request indicating a block identifier, a set of data elements, and the application data model to the blockframe component. Upon receiving the write request, the blockframe component converts the set of data elements from the application data model to a set of data units and interfaces with the blockchain instance to store the set of data units in a block identified by the block identifier. In one embodiment, the interface to store/write the data units causes creation and addition of the block to the chain of blocks.

According to another aspect of the present disclosure, the blockframe component receives read requests from different applications, with each read request specifying a corresponding data model and a corresponding block identifier. In response to each read request, the blockframe component interfaces with the blockchain instance to retrieve a corresponding set of data units from a respective block identified by the corresponding block identifier (specified in the read request). The blockframe component then converts the retrieved set of data units to a corresponding set of data elements according to the application data model specified in the read request and then provides the corresponding set of data elements (according to the respective application data model) to the application sending the read request. As such, accessing blockchain data from different applications is facilitated.

In one embodiment, the different applications and corresponding application data model are implemented according to different application programming languages. It may be appreciated that irrespective of the programming language, the different applications access the blockchain data by interacting with the blockframe component, thereby simplifying the implementation of the different applications.

According to one more aspect of the present disclosure, the blockframe component noted above is implemented to contain a corresponding wrapper component for each of multiple application programming languages, with each wrapper component being designed to receive read and write requests according to a corresponding application programming language and to transform the requests to a common set of commands. A blockchain interface component contained in the blockframe component implements each of the common set of commands by interfacing with the blockchain instance. In one embodiment, the common set of commands are part of a domain specific language (DSL).

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

2. Example Environment

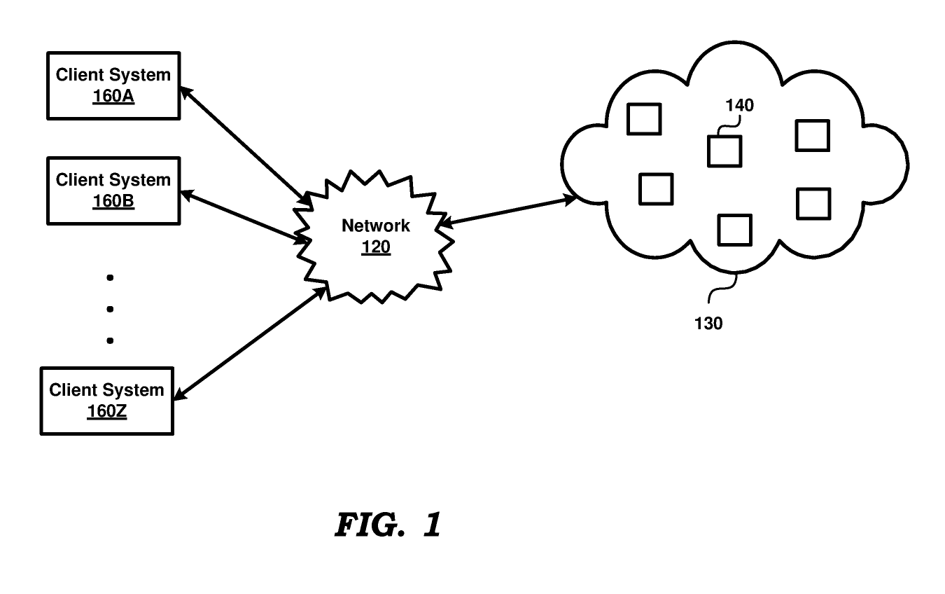

FIG. 1 is a block diagram illustrating an example environment (computing system) in which several aspects of the present invention can be implemented. The block diagram is shown containing network 120, blockchain instance 140 (in turn shown containing blockchain node 160) and client systems 160A-160Z.

Merely for illustration, only representative number/type of systems is shown in FIG. 1. Many environments often contain many more systems, both in number and type, depending on the purpose for which the environment is designed. Each block of FIG. 1 is described below in further detail.

Network 110 provides connectivity between (nodes in) blockchain instance 130 and client systems 160A-160Z and may be implemented using protocols such as Transmission Control Protocol (TCP) and/or Internet Protocol (IP), well known in the relevant arts. Network 110 may include one or more intranets and the Internet, with portions thereof being wired and wireless, as will be apparent to one skilled in the arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 110.

Blockchain instance 130 represents a chain of blocks storing data according to blockchain technology. Each block is stored in a persistent storage supported by corresponding non-volatile memory of a digital system. The blocks may be located across multiple systems/nodes (shown as square boxes within the cloud) such as blockchain node 140. Blockchain instance 130 also specifies a set of basic operations that external applications can invoke for accessing data stored in the chain of blocks. The operations are referred to as “basic” as they typically include reading a blockchain block in entirety and writing to a blockchain block in its entirety, with such read/write being performed in terms of data units such as bytes (8-bits), words (16 or 32 bits), double words (32 or 64 bits), etc. The set of basic operations may be performed by different nodes in blockchain instance 130 with the nodes coordinating with each other on a user-to-user (or peer-to-peer) basis, thereby providing a decentralized data store.

Blockchain node 140 represents a single node in blockchain instance 130 that may be storing some of the chain of blocks locally (in a non-volatile storage associated with the node). Blockchain node 140 also has the capability to receive requests for specific basic operations, perform the basic operations on the blocks maintained locally or on blocks located in other nodes of blockchain instance 130, and to send corresponding responses to the requests. In the disclosure herein, the requests/responses are assumed to be received/sent by blockchain node 140 for illustration. However, the same requests/responses may be similarly received/sent and processed by other nodes in blockchain instance 130 as will be apparent to one skilled in the relevant arts by reading the disclosure herein.

Each of client systems 160A-160Z represents a system such as a web/application server, personal computer, workstation, mobile device, computing tablet, etc., executing one or more user applications. The user applications are typically implemented using different application programming languages such as C/C++, Java™, C#™, etc. and provide different functionalities to users using client systems 160A-160Z. Example of user applications are an HR (human resources) application that facilitates users to perform various human resource functions such as employee tracking, payroll and benefits processing, etc. a PM (project management) application that facilitates users to perform project management functions such as setting project goals, tracking timelines, managing team of employees, etc. and a banking application that facilitates users to perform various financial functions such as maintaining accounts, fund transfer, etc.

It may be appreciated that some of the user applications (such as the HR and Banking application noted above) may seek to access the data stored in blockchain instance 130. For example, since alteration of data is difficult in blockchain technology, the Banking application may want to store a record of the financial transactions (such as fund transfer) using blockchain technology. Similarly, the HR application may want to store personnel information using blockchain technology.

Aspects of the present disclosure provide access to data in blockchain blocks from various applications such as HR application and Banking application noted above. To better understand the features of the present disclosure, the description is continued with the manner in which applications access data in blockchain blocks according to a prior approach.

3. Prior Approach

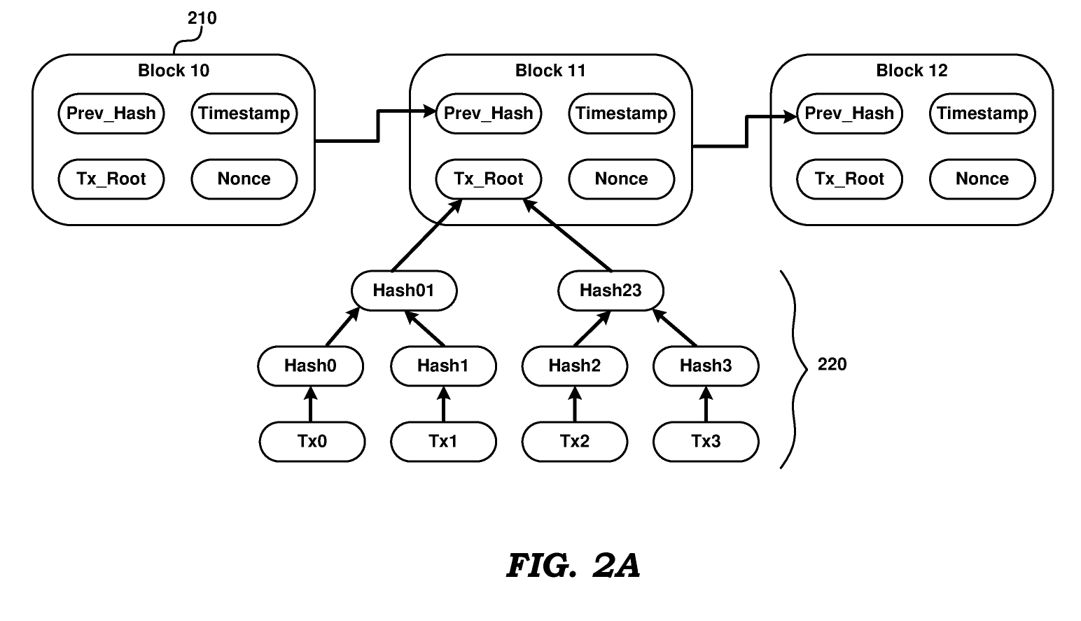

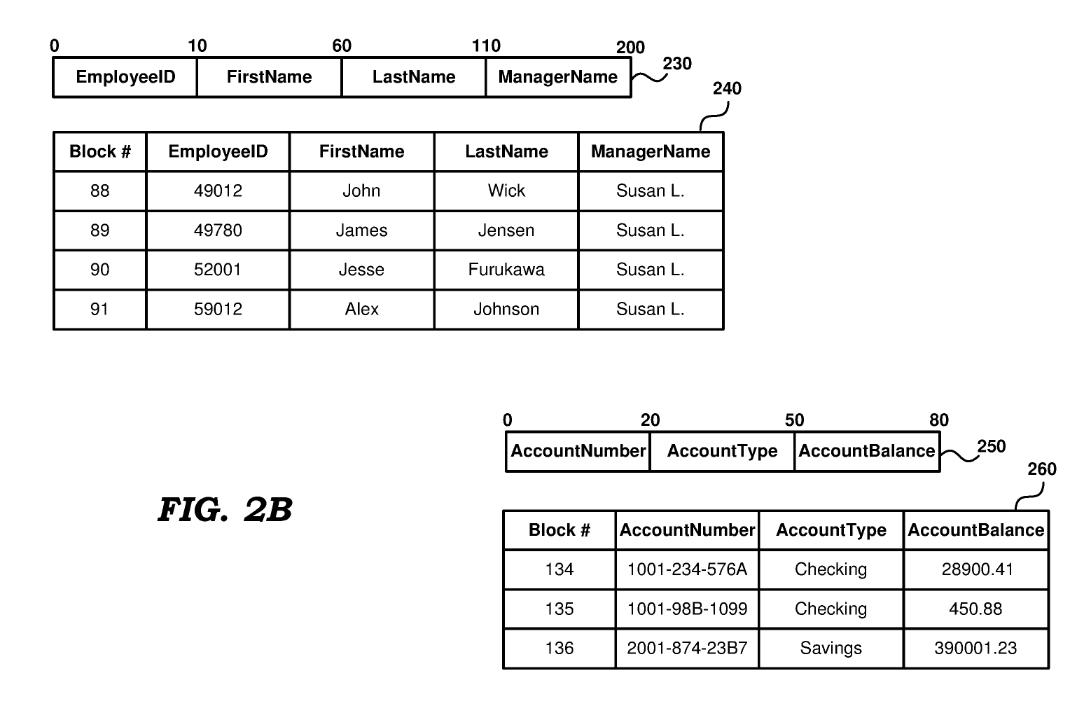

FIGS. 2A-2B and 3 together illustrates the manner in which applications access data in a prior approach. Each of the Figures is described in detail below.

FIG. 2A is a block diagram illustrating the manner in which data units are stored in a chain of blocks according to blockchain technology in one embodiment. Blockchain 210 represents a chain of blocks storing data according to blockchain technology. For illustration, blockchain 210 is shown containing 3 blocks—block 10, block 11 and block 12. However, a blockchain chain may contain fewer or larger no. of blocks (in the range of 1000+), as will be apparent to one skilled in the relevant arts.

Each block (e.g. 11) is shown containing a “Prev_Hash” field that stores a hash (signature) of previous block 10. As noted above, consistency of the “Prev_Hash” value with a hash generated (using a hash function, as is well known) based the content of previous block 10 is a requisite condition for the existence of link 215 between block 11 and previous block 10. The consistency of other links in the blockchain chain may be similarly determined and validated.

“Timestamp” field stores a unique time value that is associated with the blockchain block at the time of creation of the block. The value for the “Timestamp” field is generated by a unique timestamp server/node present in blockchain 130. “Nonce” field stores an arbitrary random number that is typically used once to provide additional security from decryption attacks.

“Tx_Root” represents a root node of a hash tree (220) using which transactions Tx0, Tx1, Tx2, etc. can be validated. As is well known, a hash tree is a tree data structure in which every leaf node (Hash0, Hash1, etc.) is labelled with the hash of a data block (transaction) and every non-leaf node (Hash01, Hash23, etc.) is labelled with the cryptographic hash of the labels of its child nodes. Such a tree data structure can be used to quickly verify any alteration to the data blocks (transactions). It should be appreciated that nodes of hash tree 220 and also the transactions are typically maintained as part of blockchain block 11.

As noted above, blockchain instance 130 provides a set of basic operations for reading and writing data units to blockchain blocks (such as 11). However, user applications executing in client systems 160A-160Z are typically implemented to operate with corresponding application data models. An application data model specifies the various data elements that form the model and the relationship among the data elements. In particular, the data model specifies a structure for the data elements. The data elements reflect the properties of the real-world entity sought to be represented by the application data model. Sample application data models that may be used by user applications is described below with examples.

FIG. 2B depicts application data models based on which (user) applications are operative in one embodiment. Data model 230 represents a model used by an HR application to represent the real-world entity of Employee. Data model 230 is shown containing data elements named “EmployeeID”, “FirstName”, “LastName”, and “ManagerName” which respectively capture information related to an employee. In addition, data model 230 specifies the data type for each of the data elements (indicated using the notation “<data type>” below the name of the data element). For example, data model 230 indicates that data element “EmployeeID” is of the data type “int” (or integer), data element “FirstName” is of the data type “string”, etc.

It may be observed that a data unit count (assumed to be byte for illustration) is shown on top of the data model to indicate the length of each of the data elements in terms of the number of data units (bytes). For example, the data unit count indicates that data element “EmployeeID” is 10 bytes long (from 0 to 10), data element “FirstName” is 50 bytes long (from 10 to 60), etc.

Table 240 depicts sample Employee transactions that may be stored in blockchain blocks using data model 230. The description is continued assuming that each transaction is stored in a corresponding blockchain block. However, in alternative embodiments, each blockchain block may store a different number and/or type of transactions (e.g. employee attendance), as will be apparent to one skilled in the relevant arts by reading the disclosure herein.

Accordingly, table 240 shows four Employee transactions (specified according to data model 230), with each transaction shown associated with a corresponding block identifier (column “Block #”). The block identifier uniquely identifies the blockchain block in which the Employee transaction is maintained.

Similarly, data model 250 represents a model used by a Banking application to represent the real-world entity of Account. Data model 250 is shown containing data elements “AccountNumber”, “AccountType”, and “AccountBalance” which respectively capture information related to an account of the user. Also, data model 250 indicates that data element “AccountNumber” is of the data type “string”, data element “AccountType” is of the data type “string”, etc. Again, a data unit/byte count is shown on top of the data model indicating that data element “AccountNumber” is 20 bytes long (from 0 to 20), data element “AccountType” is 30 bytes long (from 20 to 50), etc.

Table 260 depicts sample Account transactions that may be stored in blockchain blocks using data model 250. In particular, table 260 shows four Account transactions (specified according to data model 250), with each transaction shown associated with a corresponding block identifier (column “Block #”).

Thus, an HR application is implemented to operate with an Employee data model (230) while a banking application is implemented to operate with an Account data model (250). However, the basic operations provide by blockchain instance 130 facilitates the reading and writing of data units, which are different from the data elements specified in the application data models based on which the various applications are operative.

FIG. 3 is a block diagram illustrating the manner in which applications access data stored in a blockchain block in one prior approach. It should be appreciated that each of the applications is implemented to operate with a corresponding application data model, implying that the application data model is coded into the design of the application using a corresponding application programming language. The description is continued assuming that the applications are accessing blockchain data by interfacing with blockchain node 140 in blockchain instance 130.

HR application 310 implemented to operate with the Employee data model (230) is shown invoking various basic operations provided by blockchain node 140. As the basic operations are specified in terms of data units, HR application 310 is implemented to include procedures for translating between the data elements of the Employee data model and data units. Such translating procedures is commonly implemented in the application programming language in which HR application 310 is implemented.

Similarly, Banking application 330 implemented to operate with the Account data model (250) is shown invoking various basic operations provided by blockchain node 140. Again, as the basic operations are specified in terms of data units, Banking application 330 is implemented to include procedures for translating between the data elements of the Account data model and data units. Such translating procedures is commonly implemented in the application programming language in which Banking application 330 is implemented.

It may be appreciated that the translating procedures in different application programming languages has to be implemented consistent with the various limitations and/or specifications of the programming languages. For example, the same “int” (integer) data type is of length “4 bytes” in Java™ programming language, while is of length “2 bytes” in C/C++ programming language. Such limitations make implementation of other similar applications complex and time consuming.

PM (project management) application 320 is another application implemented to operate with Employee data model (230) and is also shown invoking various basic operations provided by blockchain node 140. It may be appreciated that PM application 320 also needs to implement (replicate) the translating procedures from the Employee data model to the data units of the blockchain block. Such an approach has the added complexity of maintenance of the replicated implementations consistent with any change to the application data model (230).

Aspects of the present disclosure provide access to blockchain data from various applications while overcoming some of the drawbacks noted above of the prior approach, as described below with examples.

4. Accessing Blockchain Data From Various Applications

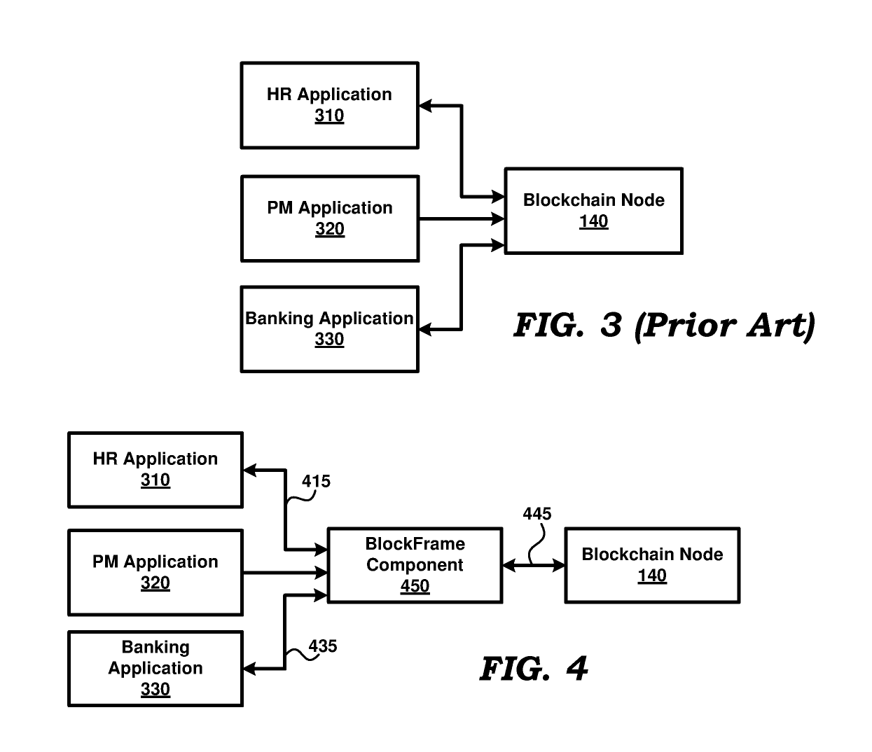

FIG. 4 is a block diagram illustrating the manner in which applications access data stored in a blockchain chain according to an aspect of the present disclosure. Each of HR application 310, PM application 320 and Banking application 330 is shown interacting with blockframe component 450, which in turn is shown interfacing with blockchain node 140.

Blockframe component 450, provided according to several aspects of the present disclosure, receives (via paths 415 and 435) read and write requests related to blockchain data and converts the received requests to corresponding one or more basic operations that can be performed by blockchain node 160.

For example, blockframe component 450 receives from an application (such as HR application 310) a write request indicating a block identifier (e.g. 88), a set of data elements (the second row/first transaction in table 240), and an application data model (Employee data model 230) and then converts the received set of data elements from the application data model to a set of data units (bytes). Blockframe component 450 then interfaces with blockchain instance 130 (in particular blockchain node 140) to store the converted set of data units in a block identified by the block identifier.

Upon receiving from another application (such as PM application 320), a read request indicating the same block identifier (88) and the same application data model (Employee), blockframe component 450 interfacing with blockchain instance 130 (in particular blockchain node 140) to retrieve the set of data units from the block identified by the block identifier. Blockframe component 450 then converts the retrieved set of data units to another set of data elements according to the application data model and provides the converted/another set of data elements to the another application as a response to the read request.

Blockframe component 450 also receives from an application (such as Banking application 330) another read request indicating another block identifier (e.g. 135) and another application data model (Account data model 250). In response, blockframe component 450 retrieves another set of data units from the block identifier by the another block identifier, converts the retrieved another set of data units to a correspond set of data elements according to the another application data model and then provides the corresponding set of data elements to the application as a response to the another read request.

Thus, blockframe component 450, provided external to applications 310/320/330, processes read and write requests received from different applications. In one embodiment described below, blockframe component 450 first receives a query request specifying the block identifier and thereafter receives the read operation and write operation request, with the read operation request indicating the application data model according which the data in the block (identified by the block identifier) is to be provided and the write operation request specifying the set of data elements (transaction) to be stored in the blockchain block and the corresponding application data model. The operation of blockframe component (450) in the processing of the query, read operation and write operation requests is described in further detail below.

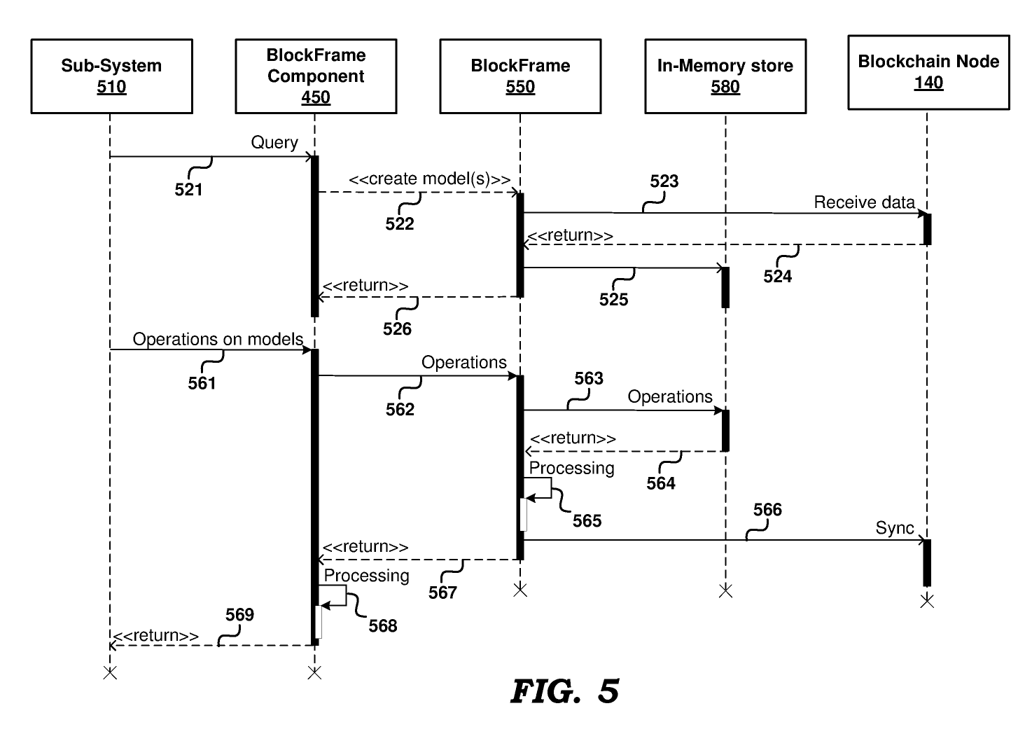

FIG. 5 is a sequence diagram illustrating the operation of blockframe component in one embodiment. Sub-system 510 represents any system that seeks access to blockchain data stored in blockchain instance 130 (by interfacing with blockchain node 160). Sub-system 510 may accordingly be one of HR application 310, PM application 320 or Banking application 330.

At 521, sub-system 510 sends a query request indicating the block identifier to blockframe component 450. At 522, blockframe component 450 creates a blockframe 550 for managing the data units retrieved from the block identified by the block identifier specified in the query request. Blockframe 550 represents a data structure that is agnostic to any application programming language.

At 523, blockframe 550 interfaces with blockchain node 140 to retrieve (at 524) data units from the specific block identified by the block identifier. At 525, blockframe 550 stores the retrieved data in in-memory database 580. As is well known, an in-memory database is a database management system that primarily relies on main memory for computer data storage, in contrast to traditional database management systems that employ a disk/non-volatile storage mechanism. At 526, blockframe 550 informs blockframe component 450 of the result (success or failure) of retrieving the block identified by the block identifier specified in the query request.

At 561, sub-system 510 sends a read/write operation request to blockframe component 450, which in turn forwards the operations to blockframe 550 at 562. Blockframe 550 in turn performs the operations on the data units (corresponding to the block identified by the block identifier) stored in in-memory database 580, and retrieves the processed data units at 564 from in-memory database 580. At 565, blockframe 550 performs additional processing of the data units such as converting data units to data elements according to an application data model in response to a read operation request and from data units to data elements to data units in response to a write operation request.

At 566, blockframe 550 performs synchronization of the data units in in-memory database 580 with the data units in the underlying blockchain block. Such synchronization ensures that any changes caused to blockchain blocks by write operation requests are immediately made available to other applications (for example, those reading the same block). At 567, blockframe 550 returns the result of processing of the read/write operation request to blockframe component 450. At 568, blockframe component 450 performs additional processing of the data units/data elements and at 569 sends the results of performance of the read/write operation requests as a response to the requesting sub-system 510. For a read operation request, the response include transactions/records according to the application data model. For a write operation request, the response may include a result indicating success or failure of the writing of the data units to the underlying blockchain block.

Thus, blockframe component 450 operates to process read requests and write requests for blockframe data received from multiple applications. It may be appreciated that irrespective of the programming language, the different applications access the blockchain data by interacting with only blockframe component 450, thereby simplifying the implementation of the different applications. The manner in which different applications are implemented to interact with blockframe component (450) is described below with examples.

5. Applications Accessing Blockchain Data

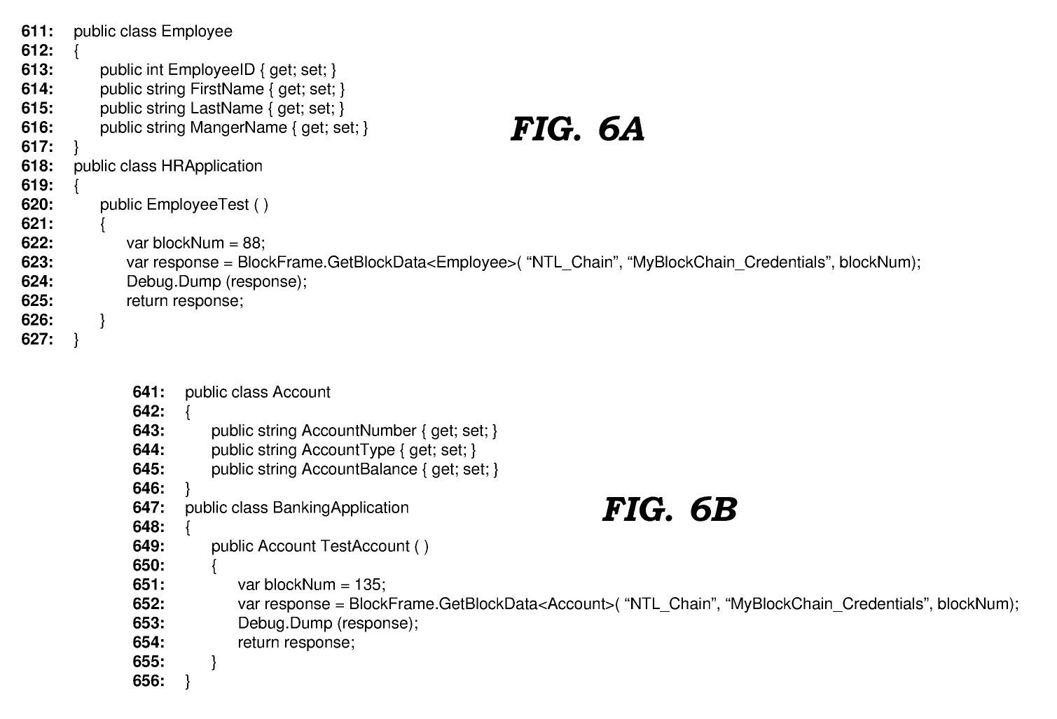

FIGS. 6A and 6B illustrate the manner in which different applications are implemented to interact with blockframe component according to an aspect of the present disclosure. In particular, FIG. 6A shows an implementation of HR application (310) for interacting with blockframe component (450), while FIG. 6B shows an implementation of Banking application (330) for interacting with blockframe component (450).

For illustration, the applications are shown implemented in C# programming language. However, the applications may be implemented in any convenient application programming language as will be apparent to one skilled in the arts by reading the disclosure herein.

Referring to FIG. 6A, lines 611-617 specifies the details of the Employee application data model such as the names of the data elements “EmployeeID”, “FirstName”, etc. and the corresponding data types (such as “int” and string”). Lines 618-627 depicts a sample implementation of HR application for interacting with blockframe component. In particular, in line 623, the “GetBlockData” procedure of blockframe component is shown invoked with the name of the blockchain instance (“NTL_Chain”), a set of credentials for accessing the blockchain instance (“MyBlockChain_Credentials”), a block number (variable blockNum set to the value “88”) and an application data model (“Employee” as indicated by the placeholder type “<Employee>”).

Thus, in line 623, a read request with the application data model and the block number is sent to blockframe component 450. In response to the read request, blockchain component 450 interfaces with blockchain node 140 to retrieve the set of data units in the blockchain block identified by the identifier (value “88”), converts the retrieved data units into an Employee record/ transaction (set of data elements) according to the Employee data model and provides the Employee record to HR application 310.

As such in line 623, the “GetBlockData” procedure is shown returning an Employee transaction/ record which is stored in the variable “response”. In lines 624 and 625, the variable “response” is shown as being printed to the screen (using Debug.Dump method) and also returned as the result of the method EmployeeTest.

Referring to FIG. 6B, lines 641-646 specifies the details of the Account application data model such as the names of the data elements “AccountNumber”, “AccountType”, etc. and the corresponding data types (such as string”). Lines 647-656 depicts a sample implementation of Banking application for interacting with blockframe component. In particular, in line 652, the “GetBlockData” procedure of blockframe component is shown invoked with the name of the blockchain instance (“NTL_Chain”), a set of credentials for accessing the blockchain instance (“MyBlockChain_Credentials”), a block number (variable blockNum set to the value “135”) and an application data model (“Account” as indicated by the placeholder type “<Account>”).

Thus, in line 652, a read request with the application data model and the block number is sent to blockframe component 450. In response to the read request, blockchain component 450 interfaces with blockchain node 140 to retrieve the set of data units in the blockchain block identified by the identifier (value “135”), converts the retrieved data units into an Account record/transaction (set of data elements) according to the Account data model and provides the Account record to Banking application 330.

As such in line 652, the “GetBlockData” procedure is shown returning an Account transaction/ record which is stored in the variable “response”. In lines 653 and 654, the variable “response” is shown as being printed to the screen (using Debug.Dump method) and also returned as the result of the method TestAccount.

Thus, different applications may be implemented to interact with blockframe component 450. It may be appreciated that such an implementation also simplifies the implementation and maintenance of other applications (such as PM application 320) using the same application data model. In particular, modifications to the application data model does not require any changes to be implemented in the application, since the invocation of the blockframe requires only the application data model to be specified. Such a feature is in contrast to the prior approach which required the translating procedures to be reimplemented for handling the modifications to the application data model.

It may be further appreciated that blockframe component is also capable of taking into consideration the specific programming language in which each of the requesting applications is implemented and provide the data elements according to the specific programming language of the requesting application. Such a feature ensures that any limitations and/or specification of the specific programming language are taken into consideration and the record/transaction provided to the application is ready for use by the application (without any additional translations).

The manner in which blockframe component (450) is implemented to provide transactions according to different application programming languages is described below with examples.

6. Blockframe Component

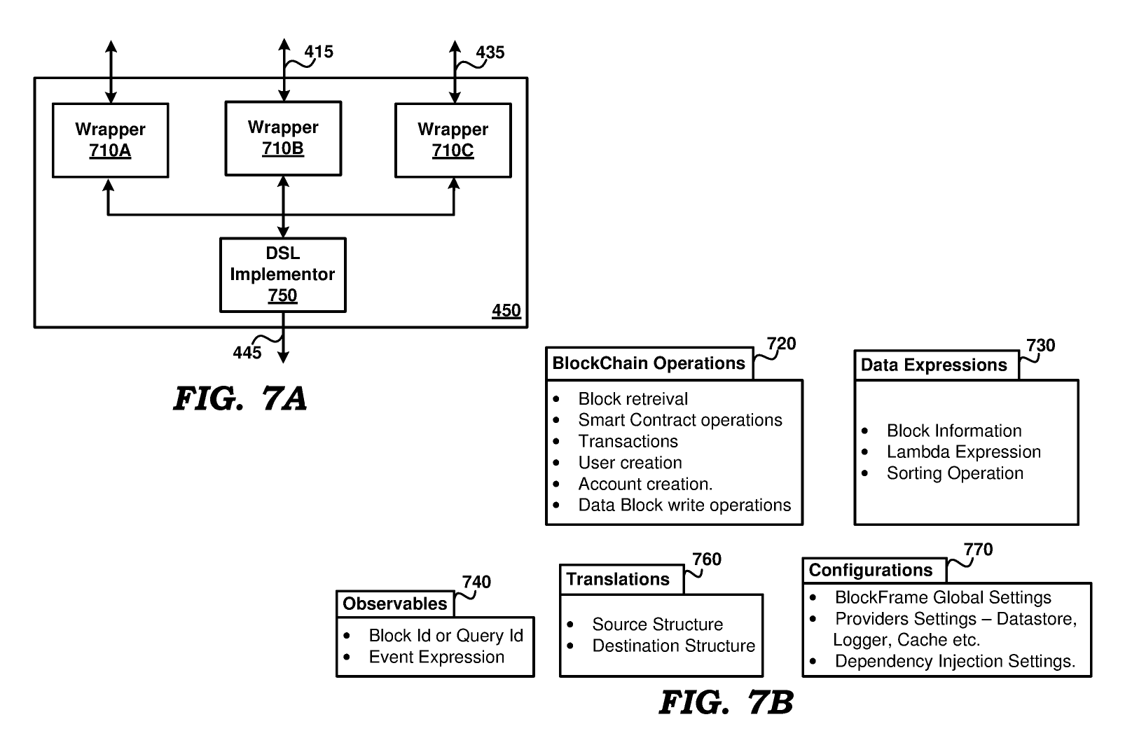

FIG. 7A is a block diagram illustrating an implementation of blockframe component (450) according to an aspect of the present disclosure. Blockframe component (450) is shown containing wrapper components 710A-710C and domain specific language (DSL) implementor 750. Each of the blocks of the Figure is described in detail below.

Each of wrapper components 710A-710C facilitates applications to interact with blockframe component in a corresponding application programming language. For example, wrapper 710B may facilitate applications implemented using C#™ programming language to interact with blockframe component while wrapper 710C may facilitate applications implemented using Java™ programming language to interact with blockframe component 450.

In particular, each wrapper component is designed to receive (via paths 415 and 435) read and write requests from the application and to transform the received requests to a common set of commands In one embodiment, the common set of commands are part of a DSL. Each wrapper component then forwards the commands to DSL implementor 450.

DSL implementor 450 implements each of the common set of commands that form part of the DSL. An example DSL that may be implemented by DSL implementor 450 is described below.

FIG. 7B depicts the details of a domain specific language (DSL) according to an aspect of the present disclosure. Broadly, the commands of the DSL may be classified into commands for blockchain operations (720), data expressions (730), observables (740), translations (760) and configurations (770). Each of the class of commands is described in detail below.

Blockchain operations 720 include commands for block retrieval, Smart Contract operations, transactions (which requires that either all or none of the commands specified as part of a transaction be performed), user creation (including user credentials) for accessing the blockchain data, account creation and blockchain block write operations.

Data expressions 730 include expressions for retrieving block information, Lambda expressions (as is well known), and sorting operations to be performed on the data elements (transactions). Observables 740 are used to monitor the accessing of the blockchain data by other users, for example, to receive a notification when a user accesses a specific block or transaction. Such monitoring can be specified based on the block identifier (for monitoring access to the corresponding block) or query identifier (for monitoring access to transactions matching the query/read request indicated by the query identifier). Alternatively, such monitoring can be specified based on event expressions, wherein notification is received when an event matching the event expression is determined to have occurred.

Translations 760 facilitates the translation of the data units retrieved from a block in response to a read request, and/or data elements received as part of a write request to corresponding source and destination structures. Configurations 770 include commands that control the blockframe (global) settings, the providers settings such as data store, logger, cache, etc. and the dependency injection settings.

Referring again to FIG. 7A, DSL implementor 450 receives one or more of the commands noted above and then performs a set of actions corresponding to the command. The set of actions performed for a command may include, but not limited to, issuing (via path 445) requests for one or basic operations to blockchain node 140, receiving the results of the requests from blockchain node 140, and forwarding the results to the wrapper component (one of 710A-710C) from which the command was received.

Each of wrapper components 710A-710C, upon receiving the results of the commands from DSL implementor 450, converts the results into data elements according to the application data models and provides the data elements (in the form of transactions or records) to the requesting application in the same application programming language in which the application is implemented.

Thus, blockframe component 450 is implemented to provide transactions according to different application programming languages. It may be appreciated that use of a domain specific language facilitates even interaction with non-programming languages. For example, a wrapper component (such as 710A) may be implemented to receive Hypertext Transfer Protocol (HTTP) requests according to Representational State Transfer (REST) architecture, and to transform them to the command set of commands forming part of the DSL.

It should be further appreciated that the features described above can be implemented in various embodiments as a desired combination of one or more of hardware, executable modules, and firmware. The description is continued with respect to an embodiment in which various features are operative when the software instructions described above are executed.

7. Digital Processing System

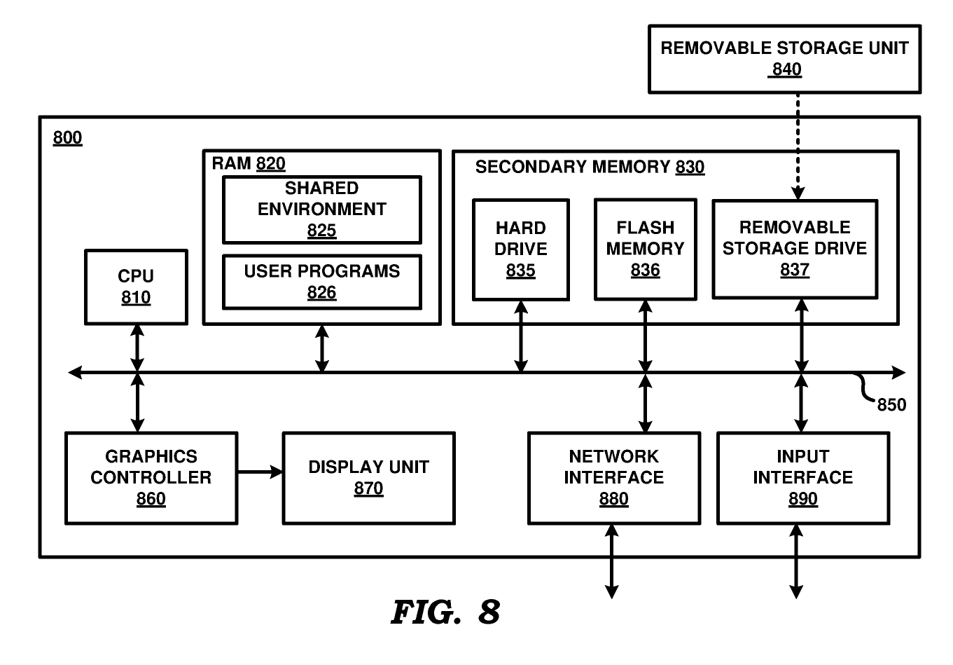

FIG. 8 is a block diagram illustrating the details of digital processing system 800 in which various aspects of the present disclosure are operative by execution of appropriate executable modules. Digital processing system 800 corresponds to any one of client systems 160A-160Z, any node (such as 140) of blockchain instance 130 or any system implementing blockframe component 450.

Digital processing system 800 may contain one or more processors such as a central processing unit (CPU) 810, random access memory (RAM) 820, secondary memory 830, graphics controller 860, display unit 870, network interface 880, and input interface 890. All the components except display unit 670 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting shared environment 825 and user programs 826. Shared environment 825 includes operating systems, device drivers, virtual machines, etc., which provide a (common) run time environment for execution of user programs 826.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) that may be used to provide appropriate inputs. Network interface 880 provides connectivity to a network (e.g., using Internet Protocol), and may be used to communicate with other systems (of FIG. 1) connected to the network (120).

Secondary memory 830 may contain hard drive 835, flash memory 836, and removable storage drive 837. Secondary memory 830 may store the data (for example, portions of the data shown in 2B) and software instructions (for example, for implementing the sequence diagram of FIG. 5, portions of the instructions shown in FIGS. 6A-6B), which enable digital processing system 800 to provide several features in accordance with the present disclosure. The code/instructions stored in secondary memory 830 either may be copied to RAM 820 prior to execution by CPU 810 for higher execution speeds, or may be directly executed by CPU 810.

Some or all of the data and instructions may be provided on removable storage unit 840, and the data and instructions may be read and provided by removable storage drive 837 to CPU 810. Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A system comprising:
a blockchain instance to store data units in a chain of blocks according to blockchain technology, said blockchain instance specifying a set of operations for accessing data in said chain of blocks;
a first application implemented to operate with a first application data model, said first application to send a write request indicating a first block identifier, a first set of data elements, and said first application data model;
a blockframe component to:
receive said write request;
convert said first set of data elements from said first application data model to a first set of data units; and
interface with said blockchain instance to store said first set of data units in a first block identified by said first block identifier.

2. The system of claim 1 further comprising a second application also implemented to operate with said first application data model, said second application to send a first read request indicating said first block identifier and said first application data model,
said blockframe component to:
receive said first read request;
interface with said blockchain instance to retrieve said first set of data units from said first block identified by said first block identifier;
convert said first set of data units to a second set of data elements according to said first application data model; and
provide said second set of data elements to said second application as a response to said first read request.

3. The system of claim 2, further comprising a third application implemented to operate with a second application data model, said third application to send a second read request indicating a second block identifier and said second application data model,
said blockframe component to:
receive said read request;
interface with said blockchain instance to retrieve a second set of data units from a second block identified by said second block identifier;
convert said second set of data units to a third set of data elements according to said second application data model; and
provide said third set of data elements to said third application as a response to said second read request.

4. The system of claim 3, wherein said second application and said second application data model are implemented in a first application programming language and said third application and said third application data model are implemented in a second application programming language.

5. The system of claim 4, wherein said blockframe component comprises:
a corresponding wrapper component for each of a plurality of application programming languages including said first application programming language and said second application programming language, each wrapper component being designed to receive read and write requests according to a corresponding application programming language and to transform the requests to a common set of commands; and
a blockchain interface component to implement each of said common set of commands by interfacing with said blockchain instance.

6. The system of claim 5, wherein said common set of commands are part of a domain specific language (DSL).

7. The system of claim 6, wherein said interface causes creation and addition of said first block to said chain of blocks.

8. A method of facilitating applications to access blockchain data stored in a blockchain instance, said blockchain instance being in the form of data units stored in a chain of blocks according to blockchain technology, said blockchain instance specifying a set of operations for accessing data in said chain of blocks, said method comprising:
receiving from a first application, a write request indicating a first block identifier, a set of data elements, and a first application data model, said first application being implemented to operate with said first application model;
converting said set of data elements from said first application data model to a first set of data units; and
interfacing with said blockchain instance to store said first set of data units in a first block identified by said first block identifier.

9. The method of claim 9, further comprising:
receiving from a second application, a first read request indicating said first block identifier and said first application data model, said second application also implemented to operate with said first application data model;
interfacing with said blockchain instance to retrieve said first set of data units from said first block identified by said first block identifier;
converting said first set of data units to a second set of data elements according to said first application data model; and
providing said second set of data elements to said second application as a response to said first read request.

10. The method of claim 9, further comprising:
receiving from a third application, a second read request indicating a second block identifier and a second application data model, said third application implemented to operate with said second application data model;
interfacing with said blockchain instance to retrieve a second set of data units from a second block identified by said second block identifier;
converting said second set of data units to a third set of data elements according to said second application data model; and
providing said third set of data elements to said third application as a response to said second read request.

11. The method of claim 10, wherein said second application and said second application data model are implemented in a first application programming language and said third application and said third application data model are implemented in a second application programming language.

12. The method of claim 11, wherein said receiving is performed by a corresponding wrapper component implemented for each of a plurality of application programming languages including said first application programming language and said second application programming language,
said method further comprising transforming by the corresponding wrapper component, the received requests to a common set of commands, wherein said common set of commands are implemented by interfacing with said blockchain instance.

13. The method of claim 12, wherein said common set of commands are part of a domain specific language (DSL).

14. The method of claim 13, wherein said interfacing causes creation and addition of said first block to said chain of blocks.

15. A non-transitory machine readable medium storing one or more sequences of instructions for causing a system to facilitate applications to access blockchain data stored in a blockchain instance, said blockchain instance being in the form of data units stored in a chain of blocks according to blockchain technology, said blockchain instance specifying a set of operations for accessing data in said chain of blocks, wherein execution of said one or more instructions by one or more processors contained in said system causes said system to perform the actions of:
receiving from a second application, a first read request indicating a first block identifier and a first application data model, said second application implemented to operate with said first application data model;
interfacing with said blockchain instance to retrieve a first set of data units from a first block identified by said first block identifier;
converting said first set of data units to a second set of data elements according to said first application data model; and
providing said second set of data elements to said second application as a response to said first read request.

16. The non-transitory machine readable medium of claim 15, further comprising one or more instructions for:
receiving from a third application, a second read request indicating a second block identifier and a second application data model, said third application implemented to operate with said second application data model;
interfacing with said blockchain instance to retrieve a second set of data units from a second block identified by said second block identifier;
converting said second set of data units to a third set of data elements according to said second application data model; and
providing said third set of data elements to said third application as a response to said second read request.

17. The non-transitory machine readable medium of claim 16, further comprising:
receiving from a first application, a write request indicating said first block identifier, a set of data elements, and said first application data model, said first application also being implemented to operate with said first application model;
converting said set of data elements from said first application data model to said first set of data units; and
interfacing with said blockchain instance to store said first set of data units in said first block identified by said first block identifier.

18. The non-transitory machine readable medium of claim 17, wherein said second application and said second application data model are implemented in a first application programming language and said third application and said third application data model are implemented in a second application programming language.

19. The non-transitory machine readable medium of claim 18, wherein said receiving is performed by a corresponding wrapper component implemented for each of a plurality of application programming languages including said first application programming language and said second application programming language,
said method further comprising transforming by the corresponding wrapper component, the received requests to a common set of commands, wherein said common set of commands are implemented by interfacing with said blockchain instance.

20. The non-transitory machine readable medium of claim 19, wherein said common set of commands are part of a domain specific language (DSL).
